(19) United States
(12) Patent Application Publication
(10) Pub. No.: US 2012/0147451 A1
(43) Pub. Date: Jun. 14, 2012

(54) Electronic paper display device and method for displaying color with the same

(75) Inventors: Jungmin Park, Gyeonggi-do (KR); Hwan Soo Lee, Seoul (KR); Young Woo LEE, Gyeonggi-do (KR); Sang Jin Kim, Gyeonggi-do (KR)

(73) Assignee: SAMSUNG ELECTRO-MECHANICS CO., LTD., Suwon (KR)

(21) Appl. No.: 13/137,060

(22) Filed: Jul. 18, 2011

(30) Foreign Application Priority Data
Dec. 9, 2010 (KR) 10-2010-0125283

(51) Int. Cl. G02F 1/167

(52) U.S. Cl. 359/296

(57) ABSTRACT

Disclosed herein is an electronic paper display device including rotating balls configured of hemispheres having colors that are in complementary relationship with each other. The rotating balls are selectively combined, thereby making it possible to represent red, green, blue, cyan, magenta, and yellow colors to the outside and control brightness and saturation of the colors.

### CROSS REFERENCE(S) TO RELATED APPLICATIONS

This application claims the benefit under 35 U.S.C. Section 119 of Korean Patent Application Serial No. 10-2010-0125283, entitled “Electronic Paper Display Device And Method For Displaying Color With The Same” filed on Dec. 9, 2010, which is hereby incorporated by reference in its entirety into this application.

### BACKGROUND OF THE INVENTION

1. Technical Field

The present invention relates to an electronic paper display device and method for displaying a color with the same, and more particularly, to an electronic paper display device having an improved color reproduction ratio, and a method for displaying a color with the same.

2. Description of the Related Art

Among next generation display devices, an electronic paper display device has availability and flexibility larger than those of other display devices and is able to be driven with low power. Therefore, the electronic paper display device may replace a paper printing medium such as a book and may be applied to various kinds of screens and electronic wallpapers, etc.

As a typical electronic paper display device, there is a twist ball type electronic paper display device using rotating balls configured of hemispheres having different colors. The twist ball type electronic paper display device includes a plurality of rotating balls, a barrier rib structure partitioning the rotating balls, and an electrode structure rotating the rotating balls. Each of the rotating balls is electrified with different charges and is configured of hemispheres having different colors.

The twist ball type electronic paper display device configured as described above has a structure in which a single rotating ball may only represent two colors. Therefore, a general electronic paper display device represents various colors by configuring a single pixel using a plurality of rotating balls having different colors and selectively rotating each of the rotating balls. Here, the electronic paper display device generally represents colors using an additive color mixture scheme of light used in a display device such as a liquid crystal display device, that is, a scheme in which red, green, and blue colors, which are the three primary colors of light, are mixed. However, unlike the liquid crystal display device having sufficient light amount, a reflective display device such as an electronic paper display device has a structure of reflecting light received from an external light source, such that it represents relatively dark colors. Therefore, the colors represented by the general electronic paper display device have relatively low brightness and saturation.

In addition, the general twist ball type electronic paper display device represents a mixed color by combining the rotating balls having the different colors. That is, the electronic paper display device represents colors other than the red, green, and blue colors by selectively combining the rotating balls configured of hemispheres having any one of the three primary colors. However, in this case, saturation of the mixed color is significantly reduced than that of the primary color. The electronic paper display device has a disadvantage in that the color purity of the mixed color is reduced, as compared to the liquid crystal display (LCD) device, etc., having its own light source.

### SUMMARY OF THE INVENTION

An object of the present invention is to provide an electronic paper display device having an improved color reproduction ratio.

Another object of the present invention is to provide an electronic paper display device having improved color purity. Particularly, the present invention is to provide an electronic paper display device in which color purities of cyan, magenta, and yellow colors other than the three primary colors are increased.

Another object of the present invention is to provide a method for manufacturing an electronic paper display device having an improved color reproduction ratio.

Another object of the present invention is to provide a method for displaying a color with an electronic paper display device having improved color purity. Particularly, the present invention is to provide a method for manufacturing an electronic paper display device in which color purities of cyan, magenta, and yellow colors other than the three primary colors are increased.

According to an exemplary embodiment of the present invention, there is provided an electronic paper display device including rotating balls configured of hemispheres having colors that are in complementary relationship with each other.

The rotating balls may include first and third rotating balls configuring a single pixel, wherein the first rotating ball may be configured of a first hemisphere having a red color and a second hemisphere having a cyan color, the second rotating ball may be configured of a third hemisphere having a green color and a fourth hemisphere having a magenta color, and the third rotating ball may be configured of a fifth hemisphere having a blue color and a sixth hemisphere having a yellow color.

The rotating balls may further include a fourth rotating ball configuring the single pixel together with the first and third rotating balls, wherein the fourth rotating ball may be configured of a seventh hemisphere having a black color and an eighth hemisphere having a white color.

When the rotating balls represent a red color, the red color may exist within a closed curve formed by four points of (0.5113,0.3800), (0.5113,0.2800), (0.3753,0.3450), (0.3753, 0.3150) within an xyY color space as measurement results obtained by a spectrophotometer (Minolta, CM-2600d).

When the rotating balls represent a green color, the green color may exist within a closed curve formed by four points of (0.3137,0.5477), (0.2183,0.5176), (0.3283,0.3852), (0.2997, 0.3761) within an xyY color space as measurement results obtained by a spectrophotometer (Minolta, CM-2600d).

When the rotating balls represent a blue color, the blue color may exist within a closed curve formed by four points of (0.2685,0.1664), (0.1889,0.2269), (0.3166,0.2876), (0.2927,0.3057) within an xyY color space as measurement results obtained by a spectrophotometer (Minolta, CM-2600d).

When the rotating balls represent a cyan color, the cyan color may exist within a closed curve formed by four points of (0.1487,0.3800), (0.1487,0.2800), (0.2847,0.3450), (0.2847,0.3150) within an xyY color space as measurement results obtained by a spectrophotometer (Minolta, CM-2600d).

When the rotating balls represent a magenta color, the magenta color may exist within a closed curve formed by four points of (0.4417,0.1424), (0.3463,0.1123), (0.3603,0.2839), (0.3317, 0.2748) within an xyY color space as measurement results obtained by a spectrophotometer (Minolta, CM-2600d).

When the rotating balls represent a yellow color, the yellow color may exist within a closed curve formed by four points of (0.4711,0.4331), (0.3915,0.4936), (0.3673,0.3543), (0.3434, 0.3724) within an xyY color space as measurement results obtained by a spectrophotometer (Minolta, CM-2600d).

A color gamut of the electronic paper display device may have a hexagonal shape formed by lines connecting coordinate values of red, green, blue, cyan, magenta, and yellow colors.

The electronic paper display device may further include a barrier rib structure including cavities having the rotating balls positioned therein; an electrode structure included in the barrier rib structure and applying a voltage to the rotating balls; and insulating oil filled in the cavities.

According to another exemplary embodiment of the present invention, there is provided a method for displaying a color with an electronic paper display device, the method including: providing rotating balls configured of hemispheres having colors that are in complementary relationship to each other and an electrode structure applying a voltage to the rotating balls, such that the electrode structure selectively rotates the rotating balls, thereby displaying a color to the outside.

The rotating balls may include: a first rotating ball configured of a first hemisphere having a red color and a second hemisphere having a cyan color; a second rotating ball configured of a third hemisphere having a green color and a fourth hemisphere having a magenta color; and a third rotating ball configured of a fifth hemisphere having a blue color and a sixth hemisphere having a yellow color, and the electrode structure may apply a voltage to the first and third rotating balls, such that the first hemisphere, the fourth hemisphere, and the sixth hemisphere face a display surface of the electronic paper display device, thereby representing a red color.

The rotating balls may include: a first rotating ball configured of a first hemisphere having a red color and a second hemisphere having a cyan color; a second rotating ball configured of a third hemisphere having a green color and a fourth hemisphere having a magenta color; and a third rotating ball configured of a fifth hemisphere having a blue color and a sixth hemisphere having a yellow color, and the electrode structure may apply a voltage to the first and third rotating balls, such that the second hemisphere, the third hemisphere, and the sixth hemisphere face a display surface of the electronic paper display device, thereby representing a green color.

The rotating balls may include: a first rotating ball configured of a first hemisphere having a red color and a second hemisphere having a cyan color; a second rotating ball configured of a third hemisphere having a green color and a fourth hemisphere having a magenta color; and a third rotating ball configured of a fifth hemisphere having a blue color and a sixth hemisphere having a yellow color, and the electrode structure may apply a voltage to the first and third rotating balls, such that the second hemisphere, the fourth hemisphere, and the fifth hemisphere face a display surface of the electronic paper display device, thereby representing a blue color.

The rotating balls may include: a first rotating ball configured of a first hemisphere having a red color and a second hemisphere having a cyan color; a second rotating ball configured of a third hemisphere having a green color and a fourth hemisphere having a magenta color; and a third rotating ball configured of a fifth hemisphere having a blue color and a sixth hemisphere having a yellow color, and the electrode structure may apply a voltage to the first and third rotating balls, such that the second hemisphere, the third hemisphere, and the fifth hemisphere face a display surface of the electronic paper display device, thereby representing a cyan color.

The rotating balls may include: a first rotating ball configured of a first hemisphere having a red color and a second hemisphere having a cyan color; a second rotating ball configured of a third hemisphere having a green color and a fourth hemisphere having a magenta color; and a third rotating balls configured of a fifth hemisphere having a blue color and a sixth hemisphere having a yellow color, and the electrode structure may apply a voltage to the first and third rotating ball, such that the first hemisphere, the fourth hemisphere, and the fifth hemisphere face a display surface of the electronic paper display device, thereby representing a magenta color.

The rotating balls may include: a first rotating ball configured of a first hemisphere having a red color and a second hemisphere having a cyan color; a second rotating ball configured of a third hemisphere having a green color and a fourth hemisphere having a magenta color; and a third rotating ball configured of a fifth hemisphere having a blue color and a sixth hemisphere having a yellow color, and the electrode structure may apply a voltage to the first and third rotating balls, such that the first hemisphere, the third hemisphere, and the sixth hemisphere face a display surface of the electronic paper display device, thereby representing a yellow color.

The rotating balls may include a fourth rotating ball configured of a seventh hemisphere having a black color and an eighth hemisphere having a white color, and the electrode structure may apply a voltage to the fourth rotating ball, thereby controlling brightness and saturation of the color represented by the rotating balls.

### BRIEF DESCRIPTION OF THE DRAWINGS

FIG. 1 is a view showing an electronic paper display device according to an exemplary embodiment of the present invention;

FIG. 2 is a plan view for describing a case in which rotating balls of the electronic paper display device according to the exemplary embodiment of the present invention represent a red color;

FIG. 3 is a plan view for describing a case in which the rotating balls of the electronic paper display device according to the exemplary embodiment of the present invention represent a green color;

FIG. 4 is a plan view for describing a case in which the rotating balls of the electronic paper display device according to the exemplary embodiment of the present invention represent a blue color;

FIG. 5 is a plan view for describing a case in which the rotating balls of the electronic paper display device according to the exemplary embodiment of the present invention represent a cyan color;

FIG. 6 is a plan view for describing a case in which the rotating balls of the electronic paper display device according to the exemplary embodiment of the present invention represent a magenta color;

FIG. 7 is a plan view for describing a case in which the rotating balls of the electronic paper display device according to the exemplary embodiment of the present invention represent a yellow color;

FIG. 8 is a graph for describing a color gamut of the electronic paper display device according to the exemplary embodiment of the present invention; and

FIG. 9 is a table showing a standard wavelength range for each color.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, an electronic paper display device and a method for displaying a color with the same according to an embodiment of the present invention will be described in detail with reference to the accompanying drawings.

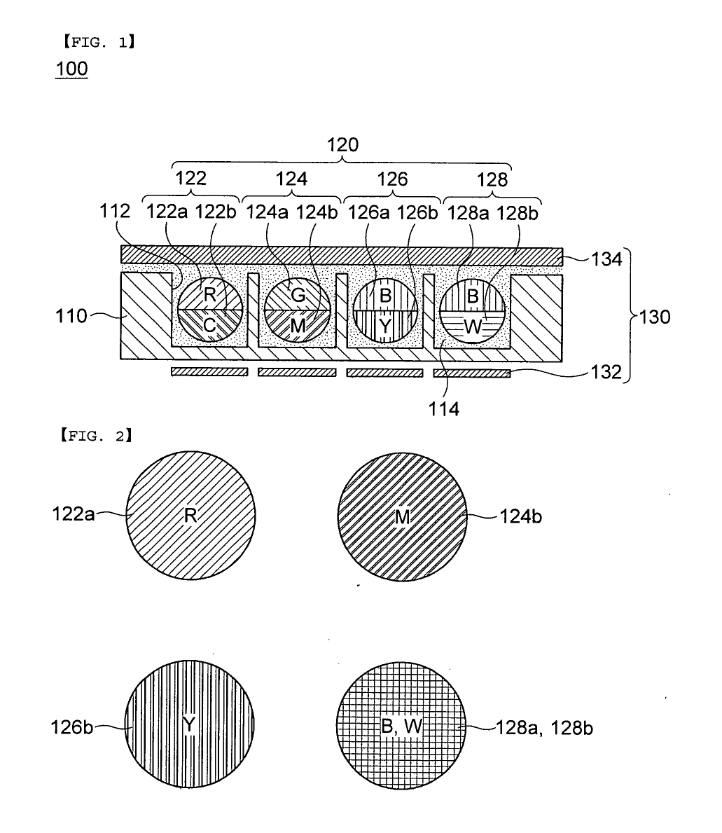

FIG. 1 is a view showing an electronic paper display device according to an exemplary embodiment of the present invention. Referring to FIG. 1, an electronic paper display device 100 according to an exemplary embodiment of the present invention may include a barrier rib structure 110, rotating balls 120, and an electrode structure 130.

The barrier rib structure 110 may support and partition the rotating balls 120. The barrier rib 110 may have cavities 112. The cavities 112 may provide spaces in which the rotating balls 120 are partitioned and disposed laterally within the barrier rib structure 110. The rotating balls 120 may be partitioned within the barrier rib structure 110 by the cavities 112. The cavities 112 may be filled with insulating oil 114. The insulating oil 114 may provide rotating lubricity of the rotating balls 120. The insulating oil 114 may be formed of a light transmitting transparent material.

The rotating balls 120 may be rotatably provided within the cavities 112. The rotating balls 120 may include first to fourth rotating balls 122, 124, 126, and 128 configuring a single pixel. Each of the first to fourth rotating balls 122, 124, 126, and 128 may have a sphere shape configured of hemispheres having different colors. Here, the hemispheres configuring a single rotating ball may be controlled to have different charge values. As an example, the hemispheres configuring the single rotating ball may be electrified with different charges. As another example, any one of the hemispheres configuring the single rotating balls may be selectively electrified.

In addition, each of the first to fourth rotating balls 122, 124, 126, and 128 may be configured of hemispheres having colors which are in complementary color relationship to each other. More specifically, the first rotating ball 122 is configured of a first hemisphere 122a and a second hemisphere 122b combined with each other, wherein the first hemisphere 122a may have a red color and the second hemisphere 122b may have a cyan color which is in complementary color relationship to the red color. The second rotating ball 124 is configured of a third hemisphere 124a and a fourth hemisphere 124b combined with each other, wherein the third hemisphere 124a may have a green color and the fourth hemisphere 124b may have a magenta color which is in complementary color relationship to the green color. The third rotating ball 126 is configured of a fifth hemisphere 126a and a sixth hemisphere 126b combined with each other, wherein the fifth hemisphere 126a may have a blue color and the sixth hemisphere 126b may have a yellow color which is in complementary color relationship to the blue color. The fourth rotating ball 128 is configured of a seventh hemisphere 128a and an eighth hemisphere 128b combined with each other, wherein the seventh hemisphere 128a may have a black color and the eighth hemisphere 128b may have a white color which is in complementary color relationship to the black color.

The electrode structure 130 can rotate the rotating balls 120. For example, the electrode structure 130 may include a lower electrode 132 that is disposed under the barrier rib structure 110 and an upper electrode 134 that is disposed over the barrier rib structure 110. The lower electrode 132 may be locally disposed under the barrier rib structure 110 so as to be opposite to each of the rotating balls 120. On the other hand, the upper electrode 134 may have a structure of covering the entire upper surface of the barrier rib structure 110 so as to be opposite to all of the rotating balls 120. The upper electrode 134 as described above may be used as a common electrode applying the same voltage to the rotating balls 120. The electrode structure 130 configured as described above selectively applies the voltage to the rotating balls 120, thereby making it possible to rotate the rotating balls 120 so that the hemispheres having colors that are to be represented among hemispheres of the rotating balls 120 face the outside (the upside in FIG. 1).

Although the present embodiment has described a case in which the lower electrode. 132 is locally disposed under the barrier rib structure 110 and the upper electrode 134 is configured to cover the entire upper surface of the barrier rib structure 110, the lower electrode 132 and the upper electrode 134 may have various shapes in order to independently drive each of the rotating balls 120. For example, as another example of the present invention, the lower electrode may be configured to cover the entire lower surface of the barrier rib structure 110, and the upper electrode may be configured to be locally disposed over the barrier rib structure 110. As another example, both of the lower and upper electrodes may be formed to have a flat panel shape.

Continuously, a method for displaying a color with the electronic paper display device according to the exemplary embodiment of the present invention described above will be described in detail. Herein, a description overlapping with the electronic paper display device 100 according to the exemplary embodiment of the present invention described above will be omitted or simplified.

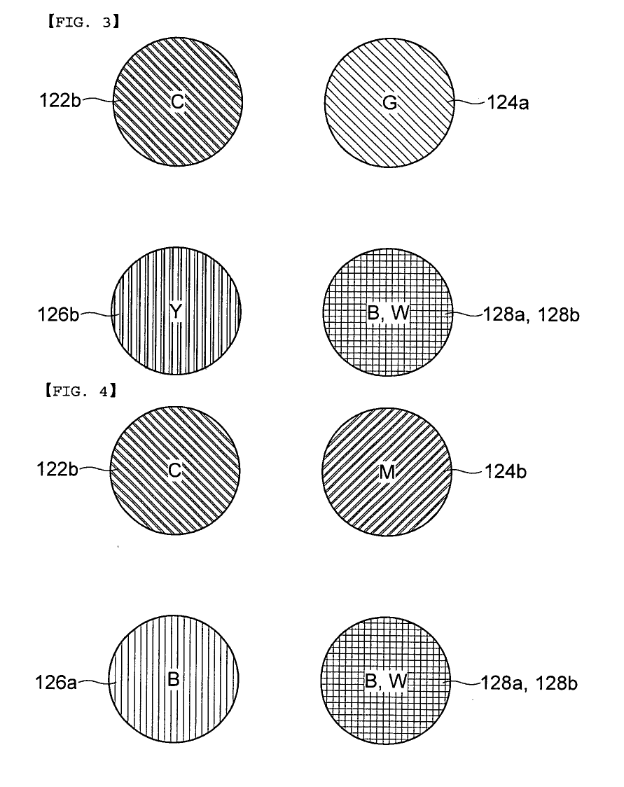

FIG. 2 is a plan view for describing a case in which rotating balls of the electronic paper display device according to the exemplary embodiment of the present invention represent a red color. Referring to FIGS. 1 and 2, when the electronic paper display device 100 according to the exemplary embodiment of the present invention is to represent a red color, the electrode structure 130 may apply a voltage to the first to third rotating balls 122, 124, and 126 so that the first hemisphere 122a, the fourth hemisphere 124b, and the sixth hemisphere 126b face the outside, which is a display surface direction of the electronic paper display device 100. Therefore, the electronic paper display device 100 may represent the red color to the outside by combining the red color of the first hemisphere 122a, the magenta color of the fourth hemisphere 124b, and the yellow color of the sixth hemisphere 126b.

In addition, the electrode structure 130 may allow any one of the seventh hemisphere 128a and the eighth hemisphere 128b of the fourth rotating ball 128 to face the outside, thereby making it possible to control brightness and saturation of the red color. For example, when the seventh hemisphere 128a having a black color faces the outside, the brightness of the red color may become low, and the saturation thereof may become high. On the other hand, when the eighth hemisphere 128b having a white color faces the outside, the brightness of the red color may become high, and the saturation thereof may become low.

FIG. 3 is a plan view for describing a case in which the rotating balls of the electronic paper display device according to the exemplary embodiment of the present invention represent a green color. Referring to FIGS. 1 and 3, when the electronic paper display device 100 according to the exemplary embodiment of the present invention is to represent a green color, the electrode structure 130 may apply a voltage to the first to third rotating balls 122, 124, and 126 so that the second hemisphere 122b, the third hemisphere 124a, and the sixth hemisphere 126b face the outside, which is a display surface direction of the electronic paper display device 100. Therefore, the electronic paper display device 100 may represent the green color to the outside by combining the cyan color of the second hemisphere 122b, the green color of the third hemisphere 124a, and the yellow color of the sixth hemisphere 126b.

In addition, the electrode structure 130 may allow any one of the seventh hemisphere 128a and the eighth hemisphere 128b of the fourth rotating ball 128 to face the outside, thereby making it possible to control brightness and saturation of the green color. For example, when the seventh hemisphere 128a having a black color faces the outside, the brightness of the green color may become low, and the saturation thereof may become high. On the other hand, when the eighth hemisphere 128b having a white color faces the outside, the brightness of the green color may become high, and the saturation thereof may become low.

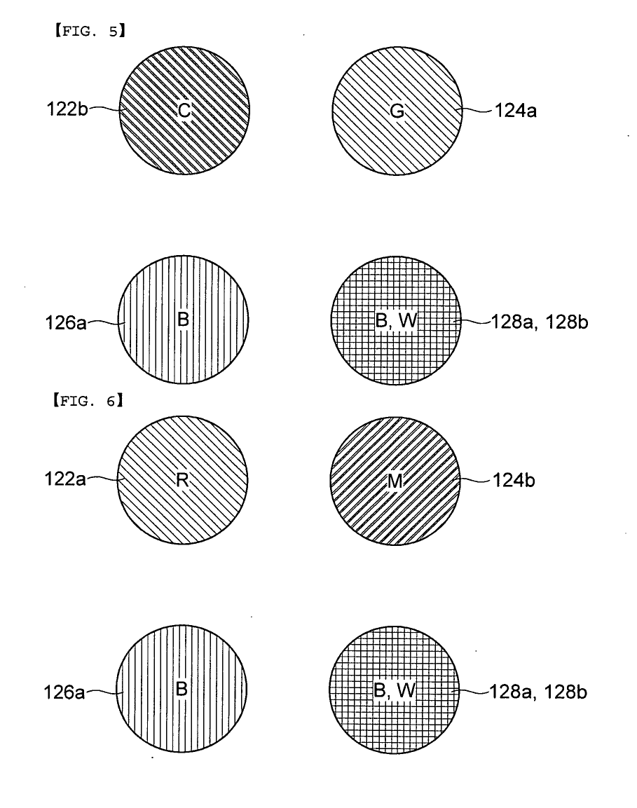

FIG. 4 is a plan view for describing a case in which the rotating balls of the electronic paper display device according to the exemplary embodiment of the present invention represent a blue color. Referring to FIGS. 1 and 4, when the electronic paper display device 100 according to the exemplary embodiment of the present invention is to represent the blue color, the electrode structure 130 may apply a voltage to the first to third rotating balls 122, 124, and 126 so that the second hemisphere 122b, the fourth hemisphere 124b, and the fifth hemisphere 126a face the outside of the electronic paper display device 100. Therefore, the electronic paper display device 100 may represent the blue color to the outside by combining the cyan color of the second hemisphere 122b, the magenta color of the fourth hemisphere 124b, and the blue color of the fifth hemisphere 126a.

In addition, the electrode structure 130 may allow any one of the seventh hemisphere 128a and the eighth hemisphere 128b of the fourth rotating ball 128 to face the outside, thereby making it possible to control brightness and saturation of the blue color. For example, when the seventh hemisphere 128a having a black color faces the outside, the brightness of the blue color may become low, and the saturation thereof may become high. On the other hand, when the eighth hemisphere 128b having a white color faces the outside, the brightness of the blue color may become high, and the saturation thereof may become low.

FIG. 5 is a plan view for describing a case in which the rotating balls of the electronic paper display device according to the exemplary embodiment of the present invention represent a cyan color. Referring to FIGS. 1 and 5, when the electronic paper display device 100 according to the exemplary embodiment of the present invention is to represent the cyan color, the electrode structure 130 may apply a voltage to the first to third rotating balls 122, 124, and 126 so that the second hemisphere 122b, the third hemisphere 124a, and the fifth hemisphere 126a face the outside of the electronic paper display device 100. Therefore, the electronic paper display device 100 may represent the cyan color to the outside by combining the cyan color of the second hemisphere 122b, the green color of the third hemisphere 124a, and the blue color of the fifth hemisphere 126a.

In addition, the electrode structure 130 may allow any one of the seventh hemisphere 128a and the eighth hemisphere 128b of the fourth rotating ball 128 to face the outside, thereby making it possible to control brightness and saturation of the cyan color. For example, when the seventh hemisphere 128a having a black color faces the outside, the brightness of the cyan color may become low, and the saturation thereof may become high. On the other hand, when the eighth hemisphere 128b having a white color faces the outside, the brightness of the cyan color may become high, and the saturation thereof may become low.

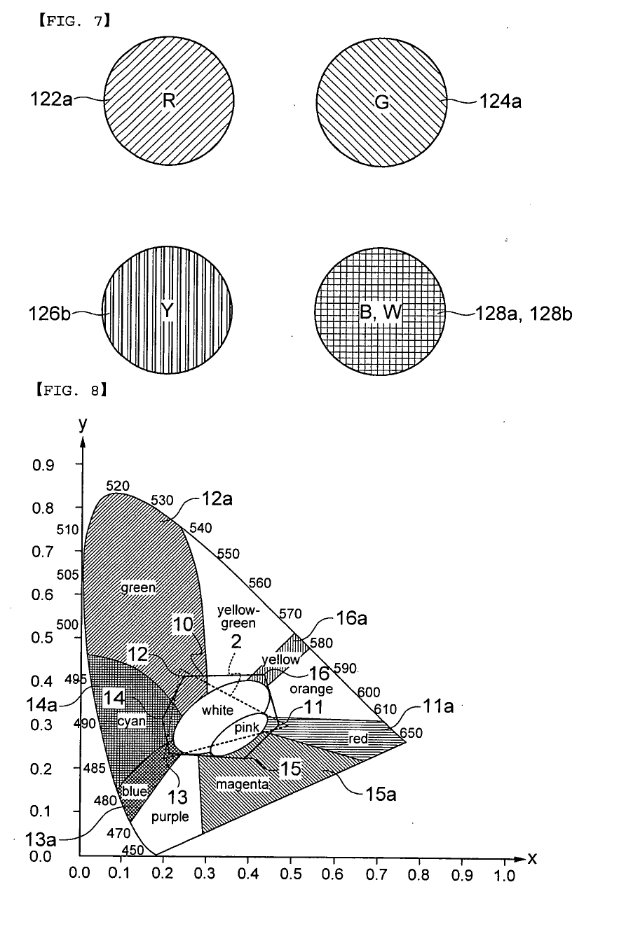

FIG. 6 is a plan view for describing a case in which the rotating balls of the electronic paper display device according to the exemplary embodiment of the present invention represent a magenta color. Referring to FIGS. 1 and 6, when the electronic paper display device 100 according to the exemplary embodiment of the present invention is to represent a magenta color, the electrode structure 130 may apply a voltage to the first to third rotating balls 122, 124, and 126 so that the first hemisphere 122a, the fourth hemisphere 124b, and the fifth hemisphere 126a face the outside of the electronic paper display device 100. Therefore, the electronic paper display device 100 may represent the magenta color to the outside by combining the red color of the first hemisphere 122a, the magenta color of the fourth hemisphere 124b, and the blue color of the fifth hemisphere 126a.

In addition, the electrode structure 130 may allow any one of the seventh hemisphere 128a and the eighth hemisphere 128b of the fourth rotating ball 128 to face the outside, thereby making it possible to control brightness and saturation of the magenta color. For example, when the seventh hemisphere 128a having a black color faces the outside, the brightness of the magenta color may become low, and the saturation thereof may become high. On the other hand, when the eighth hemisphere 128b having a white color faces the outside, the brightness of the magenta color may become high, and the saturation thereof may become low.

FIG. 7 is a plan view for describing a case in which the rotating balls of the electronic paper display device according to the exemplary embodiment of the present invention represent a yellow color. Referring to FIGS. 1 and 7, when the electronic paper display device 100 according to the exemplary embodiment of the present invention is to represent a yellow color, the electrode structure 130 may apply a voltage to the first to third rotating balls 122, 124, and 126 so that the first hemisphere 122a, the third hemisphere 124a, and the sixth hemisphere 126b face the outside of the electronic paper display device 100. Therefore, the electronic paper display device 100 may represent the yellow color to the outside by combining the red color of the first hemisphere 122a, the green color of the third hemisphere 124a, and the yellow color of the sixth hemisphere 126b.

In addition, the electrode structure 130 may allow any one of the seventh hemisphere 128a and the eighth hemisphere 128b of the fourth rotating ball 128 to face the outside, thereby making it possible to control brightness and saturation of the yellow color. For example, when the seventh hemisphere 128a having a black color faces the outside, the brightness of the yellow color may become low, and the saturation thereof may become high. On the other hand, when the eighth hemisphere 128b having a white color faces the outside, the brightness of the yellow color may become high, and the saturation thereof may become low.

As described above, the electronic paper display device 100 according to the exemplary embodiment of the present invention is configured so that each of the rotating balls 120 configuring a single pixel is configured of hemispheres having colors that are in complementary color relationship to each other, thereby making it possible to allow the single pixel to selectively represent red, green, blue, cyan, magenta, and yellow colors.

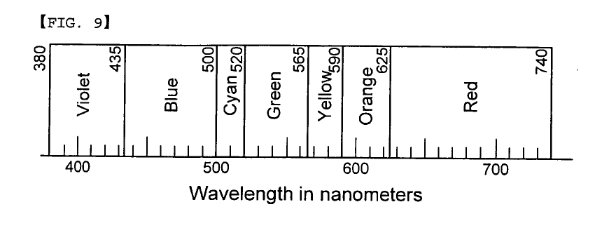

FIG. 8 is a graph for describing a color gamut of the electronic paper display device according to the exemplary embodiment of the present invention; and FIG. 9 is a table showing a standard wavelength range for each color.

Referring to FIGS. 8 and 9, it was confirmed that when the electronic paper display device 100 according to the exemplary embodiment of the present invention represents the red color as described with reference to FIG. 2, the red color exists within a closed curve formed by four points of (0.5113,0.3800), (0.5113,0.2800), (0.3753,0.3450), and (0.3753,0.3150) within an xyY color space as measurement results obtained by a spectrophotometer (Minolta, CM-2600d), such that it exists within a red range 11a of a color gamut 10. In addition, it was confirmed that the maximum value of reflectivity of the red color has a wavelength range of about 640 to 660 nm.

It was confirmed that when the electronic paper display device 100 according to the exemplary embodiment of the present invention represents the green color as described with reference to FIG. 3, the green color exists within a closed curve formed by four points of (0.3137,0.5477), (0.2183,0.5176), (0.3283,0.3852), and (0.2997,0.3761) within the xyY color space as measurement results obtained by the spectrophotometer (Minolta, CM-2600d), such that it exists within a green range 12a of the color gamut 10. In addition, it was confirmed that the maximum value of reflectivity of the green color has a wavelength range of about 540 to 560 nm.

It was confirmed that when the electronic paper display device 100 according to the exemplary embodiment of the present invention represents the blue color as described with reference to FIG. 4, the blue color exists within a closed curve formed by four points of (0.2685,0.1664), (0.1889,0.2269), (0.3166,0.2876), and (0.2927,0.3057) within the xyY color space as measurement results obtained by the spectrophotometer (Minolta, CM-2600d), such that it exists within a blue range 13a of the color gamut 10. In addition, it was confirmed that the maximum value of reflectivity of the blue color has a wavelength range of about 465 to 485 nm.

It was confirmed that when the electronic paper display device 100 according to the exemplary embodiment of the present invention represents the cyan color as described with reference to FIG. 5, the cyan color exists within a closed curve formed by four points of (0.1487,0.3800), (0.1487,0.2800), (0.2847,0.3450), and (0.2847,0.3150) within the xyY color space as measurement results obtained by the spectrophotometer (Minolta, CM-2600d), such that it exists within a cyan range 14a of the color gamut 10. In addition, it was confirmed that the maximum value of reflectivity of the cyan color has a wavelength range of about 500 to 520 nm.

It was confirmed that when the electronic paper display device 100 according to the exemplary embodiment of the present invention represents the magenta color as described with reference to FIG. 6, the magenta color exists within a closed curve formed by four points of (0.4417,0.1424), (0.3463,0.1123), (0.3603,0.2839), and (0.3317,0.2748) within the xyY color space as measurement results obtained by the spectrophotometer (Minolta, CM-2600d), such that it exists within a magenta range 15a of the color gamut 10. In addition, it was confirmed that the maximum value of reflectivity of the magenta color has an approximately mixed wavelength of the red and the blue colors.

It was confirmed that when the electronic paper display device 100 according to the exemplary embodiment of the present invention represents the yellow color as described with reference to FIG. 7, the yellow color exists within a closed curve formed by four points of (0.4711,0.4331), (0.3915,0.4936), (0.3673,0.3543), and (0.3434,0.3724) within the xyY color space as measurement results obtained by the spectrophotometer (Minolta, CM-2600d), such that it exists within a yellow range 16a of the color gamut 10. In addition, it was confirmed that the maximum value of reflectivity of the yellow color has a wavelength range of about 560 to 580 nm.

As described above, while a color gamut 2 of a general electronic paper display device has a triangle of which apices correspond to each of red, green, and blue colors, the color gamut 10 of the electronic paper display device 100 according to the exemplary embodiment of the present invention has a hexagon of which apices correspond to each of red, green, blue, cyan, magenta, and yellow colors. In this case, the electronic paper display device 100 according to the exemplary embodiment of the present invention has slightly deteriorated saturation values in the red, green, and blue colors, as compared to the electronic paper display device according to the related art; however, it has improved saturation values in cyan, magenta, and yellow colors, which are remainder colors, thereby making it possible to increase a color reproduction ratio and color purity.

As described above, the electronic paper display device 100 according to the exemplary embodiment of the present invention is configured so that each of a plurality of rotating balls 122, 124, and 126 configuring a single pixel is configured of hemispheres having colors that are in complementary color relationship to each other to selectively rotate the rotating balls 122, 124, and 126, thereby making it possible to represent red, green, blue, cyan, magenta, and yellow colors. Therefore, the electronic paper display device and the method for displaying a color with the same according to the present invention allows a single pixel to selectively represent red, green, blue, cyan, magenta, and yellow colors using the rotating balls configured of the hemispheres having colors that are in complementary color relationship to each other to increase the color gamut, thereby making it possible to improve the color reproduction ratio.

In addition, in the electronic paper display device 100 according to the exemplary embodiment of the present invention, each of the plurality of rotating balls 122, 124, and 126 configuring a single pixel may be configured of hemispheres having colors that are in complementary color relationship to each other. Also, a rotating ball (that is, a fourth rotating ball 128) configured of a hemisphere 128a having a black color and a hemisphere 128b having a white color may be further included in the single pixel. Therefore, the electronic paper display device and the method for displaying a color with the same according to the present invention may represent red, green, blue, cyan, magenta, and yellow colors and selectively control saturation and brightness of the colors, through the combination of the rotating balls configuring the single pixel, thereby making it possible to increase diversity of color representation.

As described above, the electronic paper display device according to the present invention allows a single pixel to selectively represent red, green, blue, cyan, magenta, and yellow colors using the rotating balls configured of the hemispheres having colors that are in complementary color relationship to each other to increase the color gamut, thereby making it possible to improve the color reproduction ratio.

The electronic paper display device according to the present invention may represent red, green, blue, cyan, magenta, and yellow colors and selectively control saturation and brightness of the colors, through the combination of the rotating balls configuring the single pixel, thereby making it possible to increase diversity of color representation.

The method for displaying a color with an electronic paper display device according to the present invention allows a single pixel to selectively represent red, green, blue, cyan, magenta, and yellow colors by using the rotating balls configured of the hemispheres having colors that are in complementary color relationship to each other to increase the color gamut, thereby making it possible to improve the color reproduction ratio.

The method for displaying a color with an electronic paper display device according to the present invention may represent red, green, blue, cyan, magenta, and yellow colors and selectively control saturation and brightness of the colors, through the combination of the rotating balls configuring the single pixel, thereby making it possible to increase diversity of color representation.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An electronic paper display device comprising rotating balls configured of hemispheres having colors that are in complementary relationship with each other.

2. The electronic paper display device according to claim 1, wherein the rotating balls include first to third rotating balls configuring a single pixel, and
wherein the first rotating ball is configured of a first hemisphere having a red color and a second hemisphere having a cyan color,
the second rotating ball is configured of a third hemisphere having a green color and a fourth hemisphere having a magenta color, and
the third rotating ball is configured of a fifth hemisphere having a blue color and a sixth hemisphere having a yellow color.

3. The electronic paper display device according to claim 2, wherein the rotating balls further include a fourth rotating ball configuring the single pixel together with the first to third rotating balls, and
wherein the fourth rotating ball is configured of a seventh hemisphere having a black color and an eighth hemisphere having a white color.

4. The electronic paper display device according to claim 1, wherein when the rotating balls represent a red color, the red color exists within a closed curve formed by four points of (0.5113,0.3800), (0.5113,0.2800), (0.3753,0.3450), (0.3753,0.3150) within an xyY color space.

5. The electronic paper display device according to claim 1, wherein when the rotating balls represent a green color, the green color exists within a closed curve formed by four points of (0.3137,0.5477), (0.2183,0.5176), (0.3283,0.3852), (0.2997,0.3761) within an xyY color space.

6. The electronic paper display device according to claim 1, wherein when the rotating balls represent a blue color, the blue color exists within a closed curve formed by four points of (0.2685,0.1664), (0.1889,0.2269), (0.3166,0.2876), (0.2927,0.3057) within an xyY color space.

7. The electronic paper display device according to claim 1, wherein when the rotating balls represent a cyan color, the cyan color exists within a closed curve formed by four points of (0.1487,0.3800), (0.1487,0.2800), (0.2847,0.3450), (0.2847,0.3150) within an xyY color space.

8. The electronic paper display device according to claim 1, wherein when the rotating balls represent a magenta color, the magenta color exists within a closed curve formed by four points of (0.4417,0.1424), (0.3463,0.1123), (0.3603,0.2839), (0.3317,0.2748) within an xyY color space.

9. The electronic paper display device according to claim 1, wherein when the rotating balls represent a yellow color, the yellow color exists within a closed curve formed by four points of (0.4711,0.4331), (0.3915,0.4936), (0.3673,0.3543), (0.3434,0.3724) within an xyY color space.

10. The electronic paper display device according to claim 1, wherein a color gamut of the electronic paper display device has a hexagonal shape formed by lines connecting coordinate values of red, green, blue, cyan, magenta, and yellow colors.

11. The electronic paper display device according to claim 1, further comprising:
a barrier rib structure including cavities having the rotating balls positioned therein;
an electrode structure included in the barrier rib structure and applying a voltage to the rotating balls; and
insulating oil filled in the cavities.

12. A method for displaying a color with an electronic paper display device, the method comprising:
providing rotating balls configured of hemispheres having colors that are in complementary relationship to each other and an electrode structure applying a voltage to the rotating balls, such that the electrode structure selectively rotates the rotating balls, thereby displaying a color to the outside.

13. The method according to claim 12, wherein the rotating balls include:
a first rotating ball configured of a first hemisphere having a red color and a second hemisphere having a cyan color;
a second rotating ball configured of a third hemisphere having a green color and a fourth hemisphere having a magenta color; and
a third rotating ball configured of a fifth hemisphere having a blue color and a sixth hemisphere having a yellow color, and
wherein the electrode structure applies a voltage to the first to third rotating balls, such that the first hemisphere, the fourth hemisphere, and the sixth hemisphere face a display surface of the electronic paper display device, thereby representing a red color.

14. The method according to claim 12, wherein the rotating balls include:
a first rotating ball configured of a first hemisphere having a red color and a second hemisphere having a cyan color;
a second rotating ball configured of a third hemisphere having a green color and a fourth hemisphere having a magenta color; and
a third rotating ball configured of a fifth hemisphere having a blue color-and a sixth hemisphere having a yellow color, and
wherein the electrode structure applies a voltage to the first to third rotating balls, such that the second hemisphere, the third hemisphere, and the sixth hemisphere face a display surface of the electronic paper display device, thereby representing a green color.

15. The method according to claim 12, wherein the rotating balls include:
a first rotating ball configured of a first hemisphere having a red color and a second hemisphere having a cyan color;
a second rotating ball configured of a third hemisphere having a green color and a fourth hemisphere having a magenta color; and
a third rotating ball configured of a fifth hemisphere having a blue color and a sixth hemisphere having a yellow color, and
wherein the electrode structure applies a voltage to the first to third rotating balls, such that the second hemisphere, the fourth hemisphere, and the fifth hemisphere face a display surface of the electronic paper display device, thereby representing a blue color.

16. The method according to claim 12, wherein the rotating balls include:
a first rotating ball configured of a first hemisphere having a red color and a second hemisphere having a cyan color;
a second rotating ball configured of a third hemisphere having a green color and a fourth hemisphere having a magenta color; and
a third rotating ball configured of a fifth hemisphere having a blue color and a sixth hemisphere having a yellow color, and
wherein the electrode structure applies a voltage to the first to third rotating balls, such that the second hemisphere, the third hemisphere, and the fifth hemisphere face a display surface of the electronic paper display device, thereby representing a cyan color.

17. The method according to claim 12, wherein the rotating balls include:
a first rotating ball configured of a first hemisphere having a red color and a second hemisphere having a cyan color;
a second rotating ball configured of a third hemisphere having a green color and a fourth hemisphere having a magenta color; and
a third rotating ball configured of a fifth hemisphere having a blue color and a sixth hemisphere having a yellow color, and
wherein the electrode structure applies a voltage to the first to third rotating balls, such that the first hemisphere, ₜhe fourth hemisphere, and the fifth hemisphere face a display surface of the electronic paper display device, thereby representing a magenta color.

18. The method according to claim 12, wherein the rotating balls include:
a first rotating ball configured of a first hemisphere having a red color and a second hemisphere having a cyan color;
a second rotating ball configured of a third hemisphere having a green color and a fourth hemisphere having a magenta color; and
a third rotating ball configured of a fifth hemisphere having a blue color and a sixth hemisphere having a yellow color, and
wherein the electrode structure applies a voltage to the first to third rotating balls, such that the first hemisphere, the third hemisphere, and the sixth hemisphere face a display surface of the electronic paper display device, thereby representing a yellow color.

19. The method according to claim 12, wherein the rotating balls include a fourth rotating ball configured of a seventh hemisphere having a black color and an eighth hemisphere having a white color, and
wherein the electrode structure applies a voltage to the fourth rotating ball, thereby controlling brightness and saturation of the color represented by the rotating balls.
